(19) United States
(12) Patent Application Publication
(10) Pub. No.: US 2014/0066543 A1
(43) Pub. Date: Mar. 6, 2014

(54) THERMOSETTING LIGHT-REFLECTIVE RESIN COMPOSITION, METHOD FOR PREPARING THE SAME, OPTICAL SEMICONDUCTOR ELEMENT-MOUNTED REFLECTOR PRODUCED THEREFROM, AND OPTICAL SEMICONDUCTOR DEVICE COMPRISING THE SAME

(71) Applicants: Sung-Woo Cho, Iksan-si (KR); Chul-Hui Cho, Jeonju-si (KR); Pung-Koc Hwang, Gimje-si (KR)

(72) Inventors: Sung-Woo Cho, Iksan-si (KR); Chul-Hui Cho, Jeonju-si (KR); Pung-Koc Hwang, Gimje-si (KR)

(73) Assignee: NEPESAMC, Iksan-si, Jeollabuk-do (KR)

(21) Appl. No.: 14/117,023

(22) PCT Filed: May 15, 2012
(86) PCT No.: PCT/KR2012/003792

§ 371 Date: Nov. 11, 2013

(30) Foreign Application Priority Data
May 18, 2011 (KR) 10-2011-0047065

(51) Int. Cl. G02B 1/04

(52) U.S. Cl. CPC G02B 1/04
USPC 523/400; 525/523

(57) ABSTRACT

Disclosed are a thermosetting light-reflective resin composition, a method for preparing the same, an optical semiconductor element-mounted reflector produced therefrom, and an optical semiconductor device including the same. More specifically, disclosed are a thermosetting light-reflective resin composition which includes a polyhydric polyol having two or more hydroxyl groups and thus exhibits superior discoloration resistance and entails little deterioration in reflectance, a method for preparing the same, an optical semiconductor element-mounted reflector produced therefrom and an optical semiconductor device including the same.

### TECHNICAL FIELD

Embodiments of the present invention relate to a thermosetting light-reflective resin composition which comprises a polyhydric polyol having two or more hydroxyl groups as a curing accelerator and thus causes neither yellowing nor discoloration due to superior discoloration resistance and entails little deterioration in reflectance, a method for preparing the same, an optical semiconductor element-mounted reflector produced therefrom, and an optical semiconductor device comprising the same.

### BACKGROUND ART

A light emitting diode (LED) is a light emitting device which is produced by mounting a light emitting element on a reflector and sealing the light emitting element with a material such as epoxy resin. Advantageously, such an LED is easy to mount to various equipment due to small size and low weight, has long lifespan due to excellent resistance to vibration or repeated on/off, exhibits superior visibility due to clear and remarkable color rendering (reproduction) and has low power consumption. Among LEDs, an ultraviolet light emitting element and a white LED including a phosphor emitting white light through ultraviolet light generated from the ultraviolet light emitting element attract much attention as light sources for backlights of liquid crystal display screens of cellular phones, computers, televisions and the like, headlights or instrument panels of automobiles, and luminaires.

An LED reflector used for this device generally requires high reflectance, enabling high-efficiency reflection of visible light or ultraviolet light emitted by the light emitting element. In order to prevent deterioration in reflectance, the reflector requires resistance to yellowing or discoloration. In addition, the LED reflector requires high reflectance even after thermal treatment since it is exposed to extreme heat for a long period of time.

A conventional LED reflector is obtained by plating a metal wire (lead frame) produced from a metal foil with nickel/silver or the like by a method such as punching or etching, and then producing a molded material (article) from a thermoplastic resin containing a white pigment. However, in response to consumer demand for high luminance, rated power of LCDs is recently on the rise. In this case, generated heat and ultraviolet light cause discoloration such as yellowing of the reflector, thus leading to deterioration in reflectance and luminance. A conventional light-reflective reflector formed of a thermoplastic resin article has a limitation on maintaining reflectance at a high temperature.

### DISCLOSURE

### Technical Problem

Therefore, it is one aspect of the present invention to provide a thermosetting light-reflective resin composition with superior discoloration resistance, causing neither yellowing nor discoloration.

It is another aspect of the present invention to provide a thermosetting light-reflective resin composition causing no deterioration in reflectance after thermal treatment.

It is another aspect of the present invention to provide a method for preparing the thermosetting light-reflective resin composition.

It is another aspect of the present invention to provide an optical semiconductor element-mounted reflector, including a reflector containing the thermosetting light-reflective resin composition.

It is yet another aspect of the present invention to provide an optical semiconductor device including the optical semiconductor element-mounted reflector.

### Technical Solution

In accordance with the present invention, a thermosetting light-reflective resin composition includes a polyhydric polyol having about two or more hydroxyl groups as a curing accelerator and a specimen produced using the composition has a reflectance maintenance represented by the following Equation 1, of about 70% or more:

Reflectance maintenance (%)=reflectance after thermal treatment at 180° C. for 168 hours/reflectance before thermal treatment×100 <Equation 1>

In one embodiment, the composition may have a reflectance maintenance after transfer molding, curing at about 150° C. for about 3 hours and thermal treatment at about 180° C. for about 168 hours, of about 70% or more.

In one embodiment, the composition may have a spiral flow length (S/F) during transfer molding, of about 15 inches to about 45 inches.

In one embodiment, the composition may have a gelation time (G/T) during transfer molding, of about 30 seconds to about 70 seconds.

In one embodiment, the composition may include the curing accelerator, an epoxy resin, a curing agent, an inorganic filler and a white pigment.

In one embodiment, the curing accelerator may have a structure of the following Formula 3:

OH—(CH2)m-[CR1-OH]n-(CH2)p-OH <Formula 3>

wherein R1 represents hydrogen or a C1-C30 linear or branched alkyl group, n represents an integer of 0 to 20, and m and p each independently represent an integer of 0 to 10, excluding the case that all of n, m and p are zero.

In one embodiment, the curing accelerator may not contain an aromatic functional group.

In one embodiment, the curing accelerator may be present in an amount of about 5 to about 45 parts by weight with respect to about 100 parts by weight of the epoxy resin.

In one embodiment, the epoxy resin may not contain an aromatic functional group.

In one embodiment, the curing agent may not contain an aromatic functional group.

In one embodiment, the composition may further include at least one selected from the group consisting of a release agent and an additive.

In one embodiment, the inorganic filler may be present as a mixture of an inorganic filler having a mean particle diameter (D50) of less than about 10μm and an inorganic filler having a mean particle diameter (D50) of about 10 μm to about 35 μm.

In one embodiment, the composition may include the white pigment and the inorganic filler in a weight ratio of about 1:0.1 to about 1:4.

In another aspect of the present invention, a method for preparing a thermosetting light-reflective resin composition includes melt-mixing an epoxy resin with a curing agent, and adding a curing accelerator containing a polyhydric polyol having about two or more hydroxyl groups, an inorganic filler and a white pigment to the resulting mixture, followed by melt-mixing.

In one embodiment, the melt-mixing may be carried out at a temperature of about 30° C. to about 50° C. for about 30 minutes to about 180 minutes.

In another aspect of the present invention, an optical semiconductor element-mounted reflector includes the thermosetting light-reflective resin composition.

In yet another aspect of the present invention, an optical semiconductor device includes the optical semiconductor element-mounted reflector.

### Advantageous Effects

Additional aspects of the invention will be set forth in part in the description which follows and, in part, will be obvious from the description, or may be learned by practice of the invention.

### DESCRIPTION OF DRAWINGS

FIG. 1 shows reflectance at 430 nm according to aging time after thermal treatment at 180° C. for 168 hours, of specimens produced from compositions of Examples 1 to 3 and from a composition of Comparative Example 4 comprising a curing accelerator having an aromatic functional group; and

FIG. 2 shows reflectance at 430 nm according to aging time after thermal treatment at 180° C. for 168 hours, of specimens produced from compositions of Examples 1 to 3 and from compositions of Comparative Examples 5 to 7 comprising a conventional thermoplastic resin.

### BEST MODE

In one aspect, the thermosetting light-reflective resin composition has a reflectance maintenance of about 70% or more. The term “reflectance maintenance”, as used herein, means a reflectance of a specimen made of the resin composition before thermal treatment to a reflectance of the specimen after thermal treatment at 180° C. for 168 hours. The reflectance maintenance is represented by the following Equation 1.

Reflectance maintenance (%)=reflectance after thermal treatment at 180° C. for 168 hours/reflectance before thermal treatment×100 <Equation 1>

In general, the specimen made of the light-reflective resin composition undergoes color change from white to yellow when thermally treated, thus causing deterioration in reflectance. As the deterioration in reflectance decreases, discoloration resistance increases. That is, as reflectance maintenance increases, discoloration resistance increases.

The composition has a reflectance maintenance of about 70% or more, preferably about 72% to about 85%.

A measurement method of the reflectance maintenance is not particularly limited. For example, the reflectance maintenance may be obtained by molding a composition at 150° C. for 240 seconds using a transfer molding machine, removing the composition from a die, post-curing the composition at 150° C. for 3 hours to produce a specimen, and measuring a reflectance of the specimen before thermal treatment and a reflectance thereof after thermal treatment at 180° C. for 168 hours. In the embodiment of the present invention, the reflectance is based on a value measured at a wavelength of about 430 nm.

In one embodiment, the thermosetting light-reflective resin composition has a spiral flow length (S/F) upon transfer molding, of about 15 inches to about 45 inches, preferably about 24 inches to about 45 inches.

In one embodiment, the thermosetting light-reflective resin composition has a gelation time (G/T) upon transfer molding, of about 30 seconds to about 70 seconds, preferably about 57 seconds to about 68 seconds.

The resin composition according to the embodiment may comprise an epoxy resin, a curing agent, a curing accelerator, an inorganic filler and a white pigment.

The epoxy resin that may be used in the embodiment of the present invention may be a generally used epoxy resin molding material. Examples of the epoxy resin include epoxylated phenol-aldehyde novolac resins including phenol novolac epoxy resins, orthocresol novolac epoxy resins and the like; diglycidyl ethers such as bisphenol A, bisphenol F, bisphenol S and alkyl-substituted bisphenol; glycidyl amine epoxy resins obtained by reaction of polyamine such as diaminodiphenyl methane or isocyanuric acid with epichlorohydrin; linear aliphatic epoxy resins obtained by molding an olefinic bond-containing compound with peracid such as peracetic acid; and alicyclic epoxy resins and the like. The epoxy resin may be used in combination of two or more types.

Preferably, the epoxy resin has an epoxy equivalent of about 50 g/eq to about 500 g/eq, preferably about 80 g/eq to about 450 g/eq.

Preferably, the epoxy resin does not contain an aromatic functional group. When an epoxy resin containing an aromatic functional group is applied to a reflector for a light emitting element, intense heat of the light emitting element causes yellowing and the reflector is unusable. For example, a linear aliphatic epoxy resin obtained by molding an olefinic bond-containing compound with peracid such as peracetic acid, or an alicyclic epoxy resin may be used as the epoxy resin.

For example, among epoxy resins, a triglycidyl isocyanurate resin represented by the following Formula 1 or an epoxy resin represented by the following Formula 2 that exhibits superior transparency and discoloration resistance may be used.

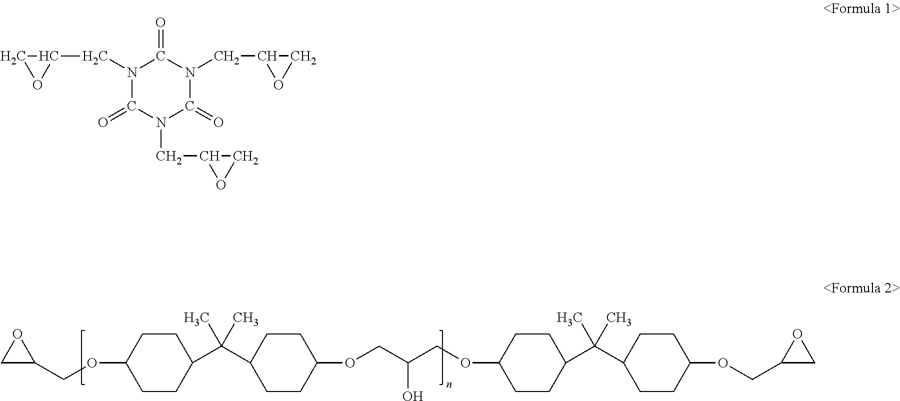

(wherein n is an integer of 0 to 20.)

In particular, the epoxy resin of Formula 2 contains one or more hydroxyl groups in an epoxy molecular structure and is thus suitable for preparation into a B-stage thermosetting resin which is not gelled by partial esterification with the curing agent and is melted again by heat.

The curing agent that can be used in the embodiment of the present invention is not particularly limited and any curing agent may be used without limitation so long as it reacts with the epoxy resin. Useful curing agents include acid anhydride curing agents, isocyanuric acid curing agents, phenolic curing agents and the like.

The curing agent may be used in combination of two or more types.

Examples of useful acid anhydride curing agents include phthalic anhydride, maleic anhydride, trimellitic anhydride, pyromellitic anhydride, hexahydrophthalic anhydride, tetrahydrophthalic anhydride, methyl nadic anhydride, nadic anhydride, glutaric anhydride, dimethyl glutaric anhydride, diethyl glutaric anhydride, succinic anhydride, methylhexahydrophthalic anhydride, methyltetrahydrophthalic anhydride and the like.

Examples of the isocyanuric acid curing agent include 1,3,5-tris(1-carboxymethyl)isocyanurate, 1,3,5-tris(2-carboxyethyl)isocyanurate, 1,3,5 -tris(3-carboxypropyl)isocyanurate, 1,3-bis(2-carboxyethyl)isocyanurate and the like.

Examples of the phenolic curing agent include a novolac-type phenol resin obtained by condensing or co-condensing phenol such as phenol, cresol, resorcine, catechol, bisphenol A, bisphenol F, phenylphenol, or aminophenol and/or naphthol such as α-naphthol, β-naphthol or dihydroxynaphthalene with a compound containing an aldehyde group such as formaldehyde, benzaldehyde or salicylic aldehyde in the presence of an acidic catalyst; a phenol-aralkyl resin synthesized from a phenol and/or a naphthol with dimethoxyparaxylene or bis(methoxy)biphenyl; an aralkyl-type phenol resin such as biphenylene-type phenol-aralkyl resin or naphthol-aralkyl resin; a dicyclopentadiene-type phenol resin such as dicyclopentadiene-type phenol novolac resin or dicyclopentadiene-type naphthol novolac resin, synthesized by copolymerization of a phenol and/or a naphthol with dicyclopentadiene; a triphenylmethane-type phenol resin; a terpene-modified phenol resin; a paraxylene- and/or metaxylene-modified phenol resin; a melamine-modified phenol resin; or a cyclopentadiene-modified phenol resin.

Preferably, the curing agent does not contain an aromatic functional group. When a curing agent containing an aromatic functional group is applied to a reflector for a light emitting diode, intense heat of the light emitting diode causes yellowing and the reflector is thus unusable. For example, the curing agent may be at least one selected from the group consisting of an acid anhydride curing agent and an isocyanuric acid curing agent. Preferably, the curing agent may be an acid anhydride curing agent.

The acid anhydride curing agent is a colorless or light-yellow curing agent.

The curing agent may be present in an amount of about 50 parts to about 250 parts by weight with respect to about 100 parts by weight of the epoxy resin. Within this range, effects of excellent high-temperature stability and electrical performance, high heat deflection temperature and superior mechanical properties can be obtained. Preferably, the curing agent is present in an amount of about 50 parts to about 200 parts by weight, more preferably about 50 parts to about 170 parts by weight.

Regarding mixing the curing agent, in particular an acid anhydride curing agent, with the epoxy resin, an active group, for example, an acid anhydride group, which can react with the epoxy group is mixed in an amount of about 0.5 equivalents to about 1.5 equivalents, with respect to 1 equivalent of the epoxy group in the epoxy resin. Within this range, decrease in curing speed of the epoxy resin composition, decrease in glass transition temperature of the cured substance and deterioration in humidity resistance of the cured substance are prevented. Preferably, the active group may be used in an amount of about 0.7 equivalents to about 1.2 equivalents.

In addition to the curing agent with respect to the epoxy resin, a curing agent obtained by partial esterification of the aforementioned acid anhydride curing agent with an alcohol or a carboxylic acid curing agent may also be used.

The curing accelerator that may be used in the embodiment of the present invention reacts with the epoxy resin and the curing agent and functions to facilitate cross-linkage. The curing accelerator may be a polyhydric alcohol having about two or more hydroxyl groups. Preferably, the curing accelerator has about three or more hydroxyl groups.

The curing accelerator is not particularly limited, but may have a structure represented by the following Formula 3.

OH—(CH2)m-[CR1-OH]n-(CH2)p-OH <Formula 3>

wherein R1 represents hydrogen or a C1 -C30 linear or branched alkyl group, n represents an integer of 0 to 20, and m and p each independently represent an integer of 0 to 10, excluding the case that all of n, m and p are zero.

Preferably, R1 represents hydrogen or a C1-C10 linear or branched alkyl group, and n represents an integer of 0 to 3.

The curing accelerator of the embodiment of the present invention has a hydroxyl group equivalent of about 30 or more, preferably about 30 to about 200, more preferably about 30 to about 150.

The curing accelerator of the embodiment of the present invention may contain no aromatic functional group. When a curing accelerator containing an aromatic functional group is used for production of a reflector, the reflector may suffer discoloration.

The curing accelerator of the embodiment of the present invention may be present in an amount of about 3 parts to about 49 parts by weight with respect to about 100 parts by weight of the epoxy resin. Within this range, non-curing of the composition caused by non-occurrence of cross-linkage between the epoxy resin and the curing agent is prevented. Preferably, the curing accelerator may be present in an amount of about 5 parts to about 45 parts by weight.

The inorganic filler is not particularly limited. For example, the inorganic filler is at least one selected from the group consisting of silica, aluminum hydroxide, magnesium hydroxide, barium sulfate, magnesium carbonate, and barium carbonate. Preferably, the inorganic filler is at least one selected from silica, aluminum hydroxide and magnesium hydroxide, in view of moldability and flame retardancy of the resin composition.

The inorganic filler has a mean particle diameter (D50) of about 35 μm or less, preferably about 1 μm to about 22 μm. The inorganic filler may be used in combination of two or more types of inorganic fillers having different mean particle diameters. For example, a combination of an inorganic filler having a mean particle diameter (D50) of less than about 10 μm, preferably about 1 μm to about 9.99 μm and of an inorganic filler of having a mean particle diameter (D50) of about 10 μm to about 35 μm may be used. When the inorganic filler has a mean particle diameter (D50) of about 10 μm to about 35 μm, flash generated between the die during transfer molding is efficiently reduced. However, when the inorganic filler is present in excess amount, it readily blocks an inlet of the cavity and thus causes incomplete filling. In this case, an inorganic filler having a mean particle diameter (D50) of less than about 10 μm and an inorganic filler having a mean particle diameter (D50) of about 10 μm to about 35 μm may be present in a weight ratio of about 1:0.1 to about 1:2.0.

The inorganic filler may be used in an amount of about 1 parts to 90 parts by weight, preferably about 5 parts to about 70 parts by weight, more preferably about 40 parts to about 45 parts by weight, with respect to about 100 parts by weight of the total weight of the thermosetting light-reflective resin composition.

The white pigment is not particularly limited and examples thereof include titanium oxide, alumina, magnesium oxide, antimony oxide, zirconium oxide, inorganic porous particles and the like.

The white pigment has a mean particle diameter (D50) of about 0.1 μm to about 50 μm. Within this range, particles do not aggregate, and dispersibility is excellent and light-reflection of the cured substance is not deteriorated. The white pigment may be used in combination of two or more types of white pigments having different mean particle diameters. The white pigment may be used in an amount of about 5 parts to about 50 parts by weight, preferably about 10 parts to about 40 parts by weight, more preferably about 15 parts to about 35 parts by weight, with respect to about 100 parts by weight of the thermosetting light-reflective resin composition.

The white pigment and the inorganic filler may be present in a weight ratio of about 1:0.1 to about 1:4. Within this range, light reflection property of the cured substance is not deteriorated, which is advantageous to mold a tablet suitable for transfer molding, and it is possible to reduce formation of bubbles inhibiting light reflection on the surface of a molded material (article) in the die when a molten substance is injected into the die, to reduce a resin flash leaked from the die and thus prevent contamination of a metal wire (lead frame) caused by the resin flash, and to easily bond and connect an optical semiconductor element to the metal wire when the optical semiconductor element is mounted to the metal wire. Preferably, the white pigment and the inorganic filler may be present in a ratio of about 1:0.2 to about 1:3.

In another embodiment, the composition of the embodiment of the present invention may further comprise at least one selected from the group consisting of a release agent and an additive.

The release agent is not particularly limited and is at least one selected from the group consisting of aliphatic carboxylic acids, aliphatic carboxylic acid esters, aliphatic polyethers, non-oxidative polyolefins and oxidative polyolefins having a carboxyl group. Preferably, the release agent is a light-colored release agent such as a colorless or light yellow release agent.

The aliphatic carboxylic acid may be a C10-0500 monovalent organic acid such as lauric acid, myristic acid, palmitic acid, stearic acid or montanic acid.

The aliphatic carboxylic acid ester has a structure represented by the following Formula 4 and is a C3-C500 polyalkylene ether compound.

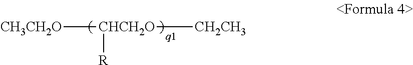

wherein q1 represents an integer of 1 to 20 and R represents hydrogen, a methyl group or a C2-C20 organic group.

The oxidative or non-oxidative polyolefin may be a low-molecular weight polyolefin having a number average molecular weight of about 500 g/mol to about 10,000 g/mol.

The release agent may be used in an amount of about 0.01 parts to about 8 parts by weight with respect to about 100 parts by weight of the epoxy resin. Within this range, adhesion to the reflector is not deteriorated. Preferably, the release agent may be used in an amount of about 1 part to about 7 parts by weight.

The additive has superior heat resistance and cold resistance, and imparts elasiticity to products in a wide temperature of about −50° C. to about 250° C. The additive may have a cross-linked linear dimethylpolysiloxane structure.

For example, the additive may be a fine silicone powder including a structure unit represented by the following Formula 5. Alternatively, the additive may be a hybrid silicone powder of a silicone resin represented by the following Formula 6 coated with the fine silicone powder represented by the following Formula 5.

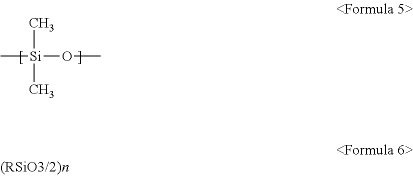

wherein R represents a methyl group, a phenyl group, a vinyl group or hydrogen and n represents an integer of 2 to 10,000.

The silicone powder has a mean particle diameter (D50) of about 0.8 μm to about 40 μm.

The additive may be present in an amount of about 0.01 parts to about 10 parts by weight, with respect to 100 parts by weight of the thermosetting light-reflective resin composition. Within this range, a molded material (article) absorbs a shock, and has improved abrasion resistance and release properties. Preferably, the additive may be present in an amount of about 0.1 parts to about 7 parts by weight.

The thermosetting light-reflective resin composition according to the embodiment of the present invention may further comprise various additives, in addition to the epoxy resin, the curing agent, the curing accelerator, the inorganic filler, the white pigment, the release agent, and the additive. For example, in terms of improvement in interface adhesion of the resin to the inorganic filler and the white pigment, a coupling agent may be used, if necessary. The coupling agent is not particularly limited and a silane coupling agent or a titanate coupling agent may be used as the coupling gent. Examples of the silane coupling agent include epoxy silane, aminosilane, cationic silane, vinyl silane, acrylic silane, and mercaptosilane coupling agents. Preferably, a content of the coupling agent is suitably controlled while taking into consideration a surface coating amount of the inorganic filler. The content of the coupling agent is preferably about 5% by weight, based on the weight of the resin composition. The thermosetting light-reflective resin composition may further comprise additives such as an antioxidant or an ion capture, in addition to the coupling agent.

Another aspect of the present invention provides a method for preparing a thermosetting light-reflective resin composition. The method may be carried out by mixing the epoxy resin, the curing agent, the curing accelerator, the inorganic filler and the white pigment, and mixing apparatus and conditions are not particularly limited. A general preparation method includes mixing various components using an apparatus such as a mixing roll, an extrusion machine, a kneader, a roll, or an extruder, and cooling and grinding the resulting mixture. The mixing is not particularly limited, but is carried out by melt mixing, and melt mixing temperature and time are controlled depending on types and amounts of components used.

In one embodiment, a mixing order of the components is not limited. A liquid molten mixture is obtained by maintaining a predetermined temperature, for example, about 100° C. to about 150° C., enabling a mixture containing the epoxy resin, the curing agent, the release agent and the additive to be molted. The molten mixture is cooled to about 30° C. to about 60° C. The curing accelerator as the remaining component and the additive, the while pigment and the inorganic filler as non-molten solid powders are added and are then melt-mixed. The melt-mixing is carried out by mixing the mixture at a temperature of about 30° C. to about 50° C., preferably about 35° C. to about 45° C. and at about 50 rpm to about 300 rpm for about 30 minutes to about 180 minutes. When a melt mixing time is shorter than 30 minutes, dispersibility of the mixture may be deteriorated, and when the melt mixing time is longer than 180 minutes, reaction heat is generated by reaction of the composition, control of the reaction is difficult and the mixture may be gelled. A mixing order of respective components is not limited, but preferably, an epoxy resin, a curing agent, a release agent and other additives are preliminarily mixed, and a curing accelerlator, a white pigment, an inorganic filler and a non-melted solid additive are then further mixed with the resulting mixture.

Another aspect of the present invention provides an optical semiconductor element-mounted reflector. The optical semiconductor element-mounted reflector may contain the thermosetting light-reflective resin composition. Specifically, the optical semiconductor element-mounted reflector includes one or more recesses and includes at least an inner side of the recess which contains the thermosetting light-reflective resin composition of the embodiment.

Another aspect of the present invention provides a method for producing the optical semiconductor element-mounted reflector. The method may include producing an inner side of the optical semiconductor element-mounted reflector using the thermosetting light-reflective resin composition. Specifically, the thermosetting light-reflective resin composition or a tablet article thereof is produced by transfer molding. The optical semiconductor element-mounted reflector is obtained through the following procedure. A metal wire is produced from a metal foil by a well-known method such as punching or etching. The metal wire (lead frame) is plated with nickel/silver. Then, the metal wire is disposed in a die and the thermosetting light-reflective resin composition of the embodiment of the present invention, that is, the molten tablet article is injected into a resin inlet of the die. Then, the injected resin composition is cured at a die temperature of about 145° C. to about 190° C. and a molding pressure of about 10 kgf/cm² to about 80 kgf/cm² for about 100 seconds to about 240 seconds, is detached from the die and is then thermally cured at a curing temperature of about 120° C. to about 180° C. for about 1 hour to about 5 hours. In addition, an organic contaminant such as resin flash present on the metal wire (lead frame) of the optical semiconductor device is removed and nickel/silver platting may be performed at a predetermined position which is surrounded by a reflector containing the cured thermosetting light-reflective resin composition and provides an area where the optical semiconductor element is mounted in order to improve reflectance of the optical semiconductor and maintain the same for a long time.

Another aspect of the present invention provides an optical semiconductor device including the optical semiconductor element-mounted reflector. The optical semiconductor device includes the optical semiconductor element-mounted reflector, an optical semiconductor element mounted on a lower surface of the recess of the optical semiconductor element-mounted reflector, and a phosphor-containing transparent sealing resin layer formed on the recess such that the phosphor-containing transparent sealing resin layer covers the optical semiconductor element. An LED may be used as the optical semiconductor element.

Hereinafter, configurations and operations of preferred embodiments will be described in more detail with reference to the following examples. These examples are provided only to illustrate the embodiments and should not be construed as limiting the scope and spirit of the embodiments.

Contents not described herein may be easily technically deduced by those skilled in the art and a detailed description thereof is thus omitted.

Detailed specification of components used for the following Examples and Comparative Example will be given below.

(1) TEPIC-S (Nissan Chemical) was used as the epoxy resin.

(2) MH-700G (Nippon Physical and Chemical) was used as the curing agent.

(3-1) PEP550 (tetravalent alcohol) (BASF Corporation) was used as the curing accelerator.

(3-2) TPP-PB (Hoko Chemical Industry) (phosphorous-based catalyst) was used as the curing accelerator.

(4) SiO2 (a mixture containing SiO2 having a mean particle diameter (D50) of 1 μm and SiO2 having a mean particle diameter (D50) of 22 μmin a weight ratio of 1:1) was used as the inorganic filler.

(5) TiO2 (mean particle diameter 0.17 μm) was used as the white pigment.

(6) PED-522 (Clariant) was used as the release agent.

(7) KBM-403 (epoxy silane) (Shin-Etsu) was used as the additive.

(8) PA-9TTA-112 (Kuraray) was used as a thermoplastic resin 1, PA-9T TA-113 (Kuraray) was used as a thermoplastic resin 2 and PA-9T TA-124 (Kuraray) was used as a thermoplastic resin 3.

### EXAMPLES 1-3

The mixture containing the epoxy resin, the curing agent, the release agent and the additive, each having a content described in Table 1 below was heated to 120° C. and was then melt-mixed. The resulting mixture was cooled to a temperature of 40° C. The white pigment, the curing accelerator and the inorganic filler were added in amounts given in the following Table 1. The resulting mixture was mixed at 100 rpm for 180 minutes while maintaining a temperature of 35° C. The resulting mixture was placed on a tray and aged in an oven at 70° C. for 3 hours and respective specimens were produced using a transfer molding machine at 150° C. for 240 seconds.

### COMPARATIVE EXAMPLES 1-4

A composition was prepared and specimens were produced in the same manner as in Examples, except that contents of respective components were changed as shown in Table 1.

TABLE 1

| | | Examples | | | Comparative Examples | | | |
|---|---|---|---|---|---|---|---|---|
| | | 1 | 2 | 3 | 1 | 2 | 3 | 4 |
| Epoxy resin | | 100 | 100 | 100 | 100 | 100 | 100 | 100 |
| (parts by weight) | | | | | | | | |
| Curing agent | | 162 | 162 | 162 | 162 | 162 | 162 | 162 |
| (parts by weight) | | | | | | | | |
| Curing | PEP550 | 5 | 25 | 45 | — | 2 | 50 | — |
| accelerator | TPP-PB | — | — | — | — | — | — | 0.7 |

| | | | | | | | |
|---|---|---|---|---|---|---|---|
| Inorganic filler | 611 | 611 | 611 | 611 | 611 | 611 | 611 |
| (parts by weight) | | | | | | | |
| White pigment | 475 | 475 | 475 | 475 | 475 | 475 | 475 |
| (parts by weight) | | | | | | | |
| Release agent (parts | 4 | 4 | 4 | 4 | 4 | 4 | 4 |
| by weight) | | | | | | | |
| Additive | 4 | 4 | 4 | 4 | 4 | 4 | 4 |
| (parts by weight) | | | | | | | |
| Total | 1361 | 1381 | 1401 | 1356 | 1358 | 1406 | 1357 |

### COMPARATIVE EXAMPLE 5

A specimen was produced by injecting a polyamide-based thermoplastic resin 1 having high heat resistance applicable to the art as a light-reflective reflector for a 0.5 watt LED in a 300° C. die by injection molding.

### COMPARATIVE EXAMPLES 6-7

Specimens of Comparative Examples 6 to 7 were produced in the same manner as in Comparative Example 5 except that thermoplastic resins 2 to 3 were used, respectively, instead of the thermoplastic resin 1.

Experimental Example: Evaluation of Physical properties

Physical properties of the specimens produced in Examples and Comparative Examples were evaluated and the results thus obtained are shown in the following Table 2.

<Measurement Method of Physical Properties>

(1) S/F (Spiral flow length) (inches): flowability during transfer molding of the compositions prepared in Examples and Comparative Examples were measured using an EMMI standard die at a die temperature of 150° C. In addition, S/F according to aging time was measured, while the compositions were aged at 70° C.

(2) G/T (gelation time) (sec): predetermined amounts of the compositions prepared in Examples and Comparative Examples were placed and reacted at 150° C. on a hot plate and a time until gelation was completed was measured. In addition, G/T according to aging time was measured, while the compositions were aged at 70° C.

(3) High-temperature hardness (Shore-A): hardness of specimens with a size of 50 mm×50 mm×3 mm (length×width×thickness) molded using the compositions prepared in Examples and Comparative Examples at a die temperature of 150° C. using a transfer molding machine was measured on a 150° C. die after 240 seconds.

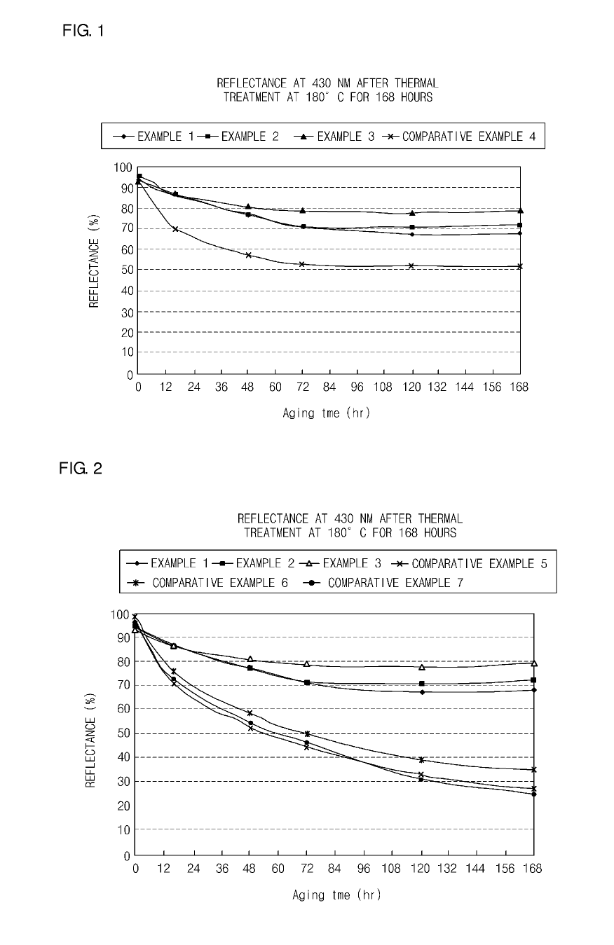

(4) Reflectance (R) (%): specimens with a size of 50 mm×50 mm×1 mm (length×width×thickness) were transfer-molded at 150° C. for 240 seconds and cured at 150° C. for three hours. Initial reflectance was measured at 430 nm using a V-670 spectrometer (JASCO Corporation). After measurement of the initial reflectance, the specimens were thermally treated at 180° C. for 168 hours, and reflectance thereof was measured again at 430 nm. FIG. 1 shows reflectance at 430 nm according to aging time, after thermal treatment of the compositions of Examples 1 to 3 and the composition of Comparative Example 4 at 180° C. for 168 hours. FIG. 2 shows reflectance at 430 nm according to aging time, after thermal treatment of the compositions of Examples 1 to 3 and the compositions of Comparative Examples 5 to 7 at 180° C. for 168 hours.

(5) Discoloration resistance (reflectance maintenance) (%): discoloration resistance (reflectance maintenance) was calculated using the measured reflectance and the following equation.

Reflectance maintenance (%)=reflectance after thermal treatment at 180° C. for 168 hours/reflectance before thermal treatment×100

(6) Detachment evaluation: a contact area of a cup-shaped molded material with a size of 3 mm×2.5 mm×2 mm (length×width×thickness) was dipped in an aqueous ink and occurrence of ink permeation by capillary action was identified. Ink permeation is represented by ◯ and no ink permeation is represented by X.

TABLE 2

| | Examples | | | Comparative Examples | | | | | | |
|---|---|---|---|---|---|---|---|---|---|---|
| | 1 | 2 | 3 | 1 | 2 | 3 | 4 | 5 | 6 | 7 |
| S/F (inch) | 40 | 24 | 45 | 103 | 103 | 103 | 42 | — | — | — |
| G/T (sec) | 65 | 57 | 68 | Un- | 100 | 130 | 39 | — | — | — |
| | | | | cured | | | | | | |
| High- | 50 | 92 | 52 | — | 10 | 12 | 92 | — | — | — |
| temperature | | | | | | | | | | |
| hardness | | | | | | | | | | |
| Reflectance | 94 | 96 | 93 | — | — | — | 93 | 97 | 98 | 96 |
| before | | | | | | | | | | |
| thermal | | | | | | | | | | |
| treatment | | | | | | | | | | |
| (%) | | | | | | | | | | |
| Reflectance | 68 | 72 | 79 | — | — | — | 52 | 26 | 35 | 25 |
| after thermal | | | | | | | | | | |
| treatment | | | | | | | | | | |
| (%) | | | | | | | | | | |
| Dis- | 72.3 | 75.0 | 84.9 | — | — | — | 55.9 | 27 | 35 | 26 |
| coloration | | | | | | | | | | |
| resistance | | | | | | | | | | |
| (reflectance | | | | | | | | | | |
| mainte- | | | | | | | | | | |
| nance) (%) | | | | | | | | | | |
| Detachment | X | X | X | — | — | — | X | X | X | X |

As can be seen from Table 2, the composition of Comparative Example 1 not containing the curing accelerator of the embodiment was not readily reacted at an aging temperature of 70° C. and remained uncured even after three hours, and preparation of a B-stage resin from the composition was difficult. The composition of Comparative Example 2 present in an amount of 2 parts by weight, with respect to 100 parts by weight of the epoxy reacted at a temperature of 70° C., as compared to Comparative Example 1 which did not contain a curing accelerator, had S/F of 103 inches or more and G/T of 100 seconds and was prepared into a B-stage resin, but had a high-temperature hardness of 10 after transfer molding and was adhered to the die. It was difficult to produce specimens for evaluating physical properties and thus perform detachment evaluation. When 50 parts by weight of the curing accelerator was contained in 100 parts by weight of the epoxy, reaction occurred at the same aging temperature, but sufficient cross-linking of the composition did not occur, and high-temperature hardness after transfer molding was low, i.e. 12 degrees. Similarly, due to difficulty of preparation of the B-stage resin, reflectance measurement and detachment evaluation were difficult to perform. On the other hand, in Examples 1, 2 and 3, reaction occurred at an aging temperature of 70° C., problems associated with preparation of the B-stage composition did not occur, hardness at a high temperature after transfer molding was 50° C. or more and problems associated with specimen production did not occur. Examples 1, 2 and 3 all had a high initial reflectance of 90% or more, and as a result of measurement of reflectance after thermal treatment at 180° C. for 168 hours, Examples 1, 2 and 3 all had a high initial reflectance of 70% or more. Comparative Example 4 using a phosphorous-based curing accelerator containing an aromatic functional group caused sufficient reaction at an aging temperature of 70° C. and a B-stage composition was prepared after 30 minutes. In addition, hardness during high-temperature transfer molding was high, there is no difficulty associated with specimen production and detachment was not observed. However, regarding discoloration resistance, Comparative Example 4 had a high initial reflectance, but considerably low reflectance after thermal treatment at high temperature, as compared to the present invention. Discoloration such as yellowing occurred after thermal treatment at a high temperature, the initial reflectance was not maintained and discoloration resistance was not good. In addition, as can be seen from the results obtained in Comparative Examples 5 to 7 and FIG. 2, the specimen made of a polyamide-based thermoplastic resin having a high heat resistance applicable as the light-reflective reflector in the art also exhibited a rapid decrease in reflectance after thermal treatment and thus poor discoloration resistance.

In addition, regarding the compositions prepared in Example and Comparative Example, S/F and G/T at 70° C. according to aging time were measured and results thus obtained are shown in the following Tables 3 and 4.

TABLE 3

| | Ex. 1 | | Ex. 2 | | Ex. 3 | |
|---|---|---|---|---|---|---|
| Aging time | S/F | G/T | S/F | G/T | S/F | G/T |
| (hour) | (inch) | (inch) | (inch) | (inch) | (inch) | (inch) |
| 0.5 | 103 | 195 | 90 | 141 | 103 | 201 |
| 1 | 96 | 130 | 70 | 94 | 95 | 123 |
| 2 | 64 | 85 | 48 | 63 | 59 | 82 |
| 3 | 40 | 65 | 24 | 57 | 45 | 68 |

TABLE 4

| Aging | Comp. Ex. 1 | | Comp. Ex. 2 | | Comp. Ex. 3 | | Comp. Ex. 4 | |
|---|---|---|---|---|---|---|---|---|
| time | S/F | G/T | S/F | G/T | S/F | G/T | S/F | G/T |
| (hour) | (inch) | (inch) | (inch) | (inch) | (inch) | (inch) | (inch) | (inch) |
| 0.5 | 103 | Uncured | 103 | Uncured | 103 | Uncured | 42 | 39 |
| 1 | 103 | Uncured | 103 | Uncured | 103 | Uncured | 0 | Gelled |
| 2 | 103 | Uncured | 103 | 600 | 103 | 500 | 0 | Gelled |
| 3 | 103 | Uncured | 103 | 100 | 103 | 130 | 0 | Gelled |

As described above, the composition of the present invention was prepared into a B-stage having suitable S/F and G/T values, while the compositions of Comparative Examples 1 to 3 did not have suitable S/F and G/T values, although the compositions were uncured or prepared into a B-stage resin. However, in Comparative Example 4, within a relatively short time after 0.5 hours, the B-stage resin had suitable S/F and G/T values, did not have flowability and was gelled, and thus G/T could not be measured.

Embodiments of the present invention provide a thermosetting light-reflective resin composition causing neither yellowing nor discoloration due to superior discoloration resistance. In addition, embodiments of the present invention provide a thermosetting light-reflective resin composition causing no deterioration in reflectance even after exposure to high temperatures for a long period of time.

### INDUSTRIAL APPLICABILITY

Therefore, the present invention can be applied to technologies for a thermosetting light-reflective resin composition with superior discoloration resistance, causing neither yellowing nor discoloration. In addition, the present invention can be applied to technologies for a thermosetting light-reflective resin composition causing no deterioration in reflectance even after exposure to high temperatures for a long period of time.

Although a few embodiments of the present invention have been shown and described, it would be appreciated by those skilled in the art that changes may be made in these embodiments without departing from the principles and spirit of the invention, the scope of which is defined in the claims and their equivalents.

1. A thermosetting light-reflective resin composition comprising a polyhydric polyol having two or more hydroxyl groups as a curing accelerator, wherein a specimen produced using the composition has a reflectance maintenance represented by the following Equation 1, of about 70% or more:
Reflectance maintenance (%)=reflectance after thermal treatment at 180° C. for 168 hours/reflectance before thermal treatment×100 <Equation 1>

2. The thermosetting light-reflective resin composition according to claim 1, wherein the hydroxyl groups include three or more hydroxyl groups.

3. The thermosetting light-reflective resin composition according to claim 1, wherein the composition has a reflectance maintenance after transfer molding, curing at about 150° C. for about 3 hours and thermal treatment at about 180° C. for about 168 hours, of about 70% or more.

4. The thermosetting light-reflective resin composition according to claim 1, wherein the composition has a spiral flow length (S/F) during transfer molding of about 15 inches to about 45 inches.

5. The thermosetting light-reflective resin composition according to claim 1, wherein the composition has a gelation time (G/T) during transfer molding of about 30 seconds to about 70 seconds.

6. The thermosetting light-reflective resin composition according to claim 1, wherein the curing accelerator has a hydroxyl group equivalent of about 30 or more.

7. The thermosetting light-reflective resin composition according to claim 1, wherein the curing accelerator does not contain an aromatic functional group.

8. The thermosetting light-reflective resin composition according to claim 1, wherein the curing accelerator has a structure of the following Formula 3:
OH-(CH2)m-[CR1-OH]n-(CH2)p-OH <Formula 3>
wherein R1 represents hydrogen or a C1-C30 linear or branched alkyl group, n represents an integer of 0 to 20, and m and p each independently represent an integer of 0 to 10, excluding the case that all of n, m and p are zero

9. The thermosetting light-reflective resin composition according to claim 1, wherein
the composition includes the curing accelerator, an epoxy resin, a curing agent, an inorganic filler and a white pigment.

10. The thermosetting light-reflective resin composition according to claim 9, wherein the curing accelerator is present in an amount of about 3 parts to about 49 parts by weight with respect to about 100 parts by weight of the epoxy resin.

11. The thermosetting light-reflective resin composition according to claim 9, wherein the epoxy resin does not contain an aromatic functional group.

12. The thermosetting light-reflective resin composition according to claim 9, wherein the curing agent does not contain an aromatic functional group.

13. The thermosetting light-reflective resin composition according to claim 9, wherein the composition comprises the white pigment and the inorganic filler in a weight ratio of about 1:0.1 to about 1:4.

14. The thermosetting light-reflective resin composition according to claim 9, wherein the inorganic filler is present as a mixture of an inorganic filler having a mean particle diameter (D50) of less than about 10 μm and an inorganic filler having a mean particle diameter (D50) of about 10 μm to about 35 μm.

15. The thermosetting light-reflective resin composition according to claim 9, further comprising at least one selected from the group consisting of a release agent and an additive.

16. The thermosetting light-reflective resin composition according to claim 15, wherein the additive has a cross-linked linear dimethylpolysiloxane structure.

17. A method for preparing a thermosetting light-reflective resin composition comprising:
melt-mixing an epoxy resin with a curing agent; and
adding a curing accelerator containing a polyhydric polyol having about two or more hydroxyl groups, an inorganic filler and a white pigment to the resulting mixture, followed by melt-mixing.

18. The method according to claim 17, wherein the melt-mixing is carried out at a temperature of about 30° C. to about 50° C. for about 30 minutes to about 180 minutes.

19. An optical semiconductor element-mounted reflector comprising the thermosetting light-reflective resin composition according to claim 1.

20. An optical semiconductor device comprising the optical semiconductor element-mounted reflector according to claim 19.
